(19) United States
(12) Patent Application Publication
(10) Pub. No.: US 2014/0212703 A1
(43) Pub. Date: Jul. 31, 2014

(54) BATTERY PACK

(71) Applicant: DAI NIPPON PRINTING CO., LTD., Tokyo (JP)

(72) Inventors: Hiroyuki Kobori, Tokyo (JP); Yozo Kosaka, Tokyo (JP); Keisuke Nomura, Tokyo (JP); Yuuki Kumagai, Tokyo (JP); Chihiro Sato, Tokyo (JP)

(73) Assignee: DAI NIPPON PRINTING CO., LTD., Tokyo (JP)

(21) Appl. No.: 14/236,378

(22) PCT Filed: Jan. 9, 2013
(86) PCT No.: PCT/JP2013/050707

§ 371 Date: Jan. 31, 2014

(30) Foreign Application Priority Data
Jan. 16, 2012 (JP) 2012-006325
Jan. 20, 2012 (JP) 2012-009784
Jun. 29, 2012 (JP) 2012-146760

(51) Int. Cl. H01M 4/36

(52) U.S. Cl. CPC H01M 4/364
USPC 429/7; 429/231.6; 252/182.1

(57) ABSTRACT

A battery pack includes a magnesium ion rechargeable battery, allowing electrical charge and discharge regardless the type of the electrolyte, and improving the cycle characteristic and the electrical charge and discharge efficiency. The battery pack includes a storage case, a magnesium ion rechargeable battery which contains a positive terminal and a negative terminal, and a protection circuit which possesses an over-charge protection function and an over-discharge function. The magnesium ion rechargeable battery and the protection circuit are stored in the storage case. The magnesium ion rechargeable battery includes a positive plate, a negative plate and an electrolyte. The negative plate includes a material for the negative plate of the magnesium ion rechargeable battery. The material for the negative plate of the magnesium ion rechargeable battery includes magnesium metal and an allotrope of carbon. The magnesium metal and the allotrope of carbon are in at least partial contact with each other.

### TECHNICAL FIELD

This invention is related to a battery pack, more particularly, this invention is related to the battery pack which includes a magnesium ion rechargeable battery.

### BACKGROUND ART

Recently, environmental problems, such as global warming, which are presumed to be caused by the increment of carbon dioxide, has been adversely developed, and thus, measures against the problems has been studied and proceeded all across the world.

Among them, the rechargeable battery, typically, lithium ion rechargeable battery, has been studied and developed enthusiastically, since it gives little influence on the environment, and thus, is estimated as a clean energy's source.

In addition, a certain rechargeable battery which can have a higher energy density than that of the lithium metal has been also sought nowadays, and as achievements, various suggestions has been offered with respect to magnesium ion rechargeable battery, wherein magnesium metal, an abundant resource, is used, and which battery being excellent in safety.

It is desirable in the magnesium ion rechargeable battery to use a magnesium metal-including negative plate material for the negative plate. However, it is known that the magnesium metal forms magnesium oxide film on the surface thereof, which is due to moisture in the atmosphere or included in an electrolyte solution using an aqueous solvent. Since the magnesium oxide film is a passive film, the movement of the magnesium ion from the magnesium metal to the electrolyte and the movement of the magnesium ion from the electrolyte to the magnesium metal is obstructed by the presence of the magnesium oxide film formed on the surface of the magnesium metal, and as a result, a remarkable decrease in electrical charge and discharge efficiency and cycle characteristics is unavoidably caused. Moreover, in some cases, the impossibility of electrical charge and discharge may arise.

In order to solve the above problems, measures on the electrolyte are practiced at present. For instance, it is known that the formation of the magnesium oxide film on the surface of the magnesium metal can be repressed by using an ethereal solution of Grignard reagent (RMgX: wherein R represents an alkyl group or an aryl group, Mg represents magnesium, and X represents one of iodine, bromine or chlorine) as the electrolyte.

In addition to the above instance, in the Patent Literature 1, an electrolyte, in which magnesium metal, alkyl trifluoromethane sulfonate, and an quaternary ammonium salt and/or 1,3-alkyl methyl imidazolinium salt are added to an ether type organic solvent, and magnesium ions are dissolved in the ether type organic solvent, has been proposed as an electrolyte capable of exploit the potential of superior characteristics of magnesium metal adequately.

### LITERATURE IN THE PRIOR ART

### Patent Literature

(Patent Literature 1) WO 2009/148112

### SUMMARY OF INVENTION

### Problems to be Solved by the Present Invention

However, if can be hardly said that cycle characteristic and the electrical charge and discharge efficiency are enough with the magnesium metal-including negative plate which is presently known, even in the case of using the electrolyte which is proposed in the above literature, or the like, and thus, there is still room for improvement. Moreover, a demand in the market for the magnesium ion rechargeable battery capable of being charged and discharged electrically regardless the type of the electrolyte is high, and the improvement for this respect is also desired.

The present invention is contrived under such a situation, and the present invention is aimed to provide a material for a negative plate of a magnesium ion rechargeable battery, a negative plate for a magnesium ion rechargeable battery, and a magnesium ion rechargeable battery, as well as a battery pack, which make electrical charge and discharge regardless the type of the electrolyte possible, and improve the cycle characteristic and the electrical charge and discharge efficiency.

### Means for Solving the Problems

The present invention for solving the above-mentioned problems is embodied in a material for a negative plate of a magnesium ion rechargeable battery which is characterized in that the material comprises magnesium metal and an allotrope of carbon, and the magnesium metal and the allotrope of carbon are in contact with each other at least in part.

Further, the present invention for solving the above-mentioned problems is also embodied in a negative plate for a magnesium ion rechargeable battery which is characterized in that the negative plate comprises a material for a negative plate of a magnesium ion rechargeable battery, wherein the material comprises magnesium metal and an allotrope of carbon, and the magnesium metal and the allotrope of carbon are in contact with each other at least in part.

Moreover, the present invention for solving the above-mentioned problems is also embodied in a magnesium ion rechargeable battery which comprises a positive plate, a negative plate and an electrolyte, wherein the negative plate comprises a material for a negative plate of a magnesium ion rechargeable battery, wherein the material comprises magnesium metal and an allotrope of carbon, and the magnesium metal and the allotrope of carbon are in contact with each other at least in part.

Further more, the present invention for solving the above-mentioned problems is also embodied in a battery pack which comprises a storage case, a magnesium ion rechargeable battery which contains a positive terminal and a negative terminal, and a protection circuit which possesses an over-charge protection function and an over-discharge function, wherein the magnesium ion rechargeable battery and the protection circuit are stored in the storage case, and the battery pack is characterized in that the magnesium ion rechargeable battery comprises a positive plate, a negative plate and an electrolyte, wherein the negative plate comprises a material for the negative plate of the magnesium ion rechargeable battery, wherein the material comprises magnesium metal and an allotrope of carbon, and the magnesium metal and the allotrope of carbon are in contact with each other at least in part.

### Effect of the Invention

According to the material for the negative plate of the magnesium ion rechargeable battery of the present invention, it is possible to provide a magnesium ion rechargeable battery which makes electrical charge and discharge regardless the type of the electrolyte possible, and improves the cycle characteristic and the electrical charge and discharge efficiency. Further, according to the negative plate of magnesium ion rechargeable battery, the magnesium ion rechargeable battery, and the battery pack, each of which utilizes the material for the negative plate of the magnesium ion rechargeable battery can enjoy the function and effect owing to the above-mentioned material for the negative plate.

### BRIEF DESCRIPTION OF DRAWINGS

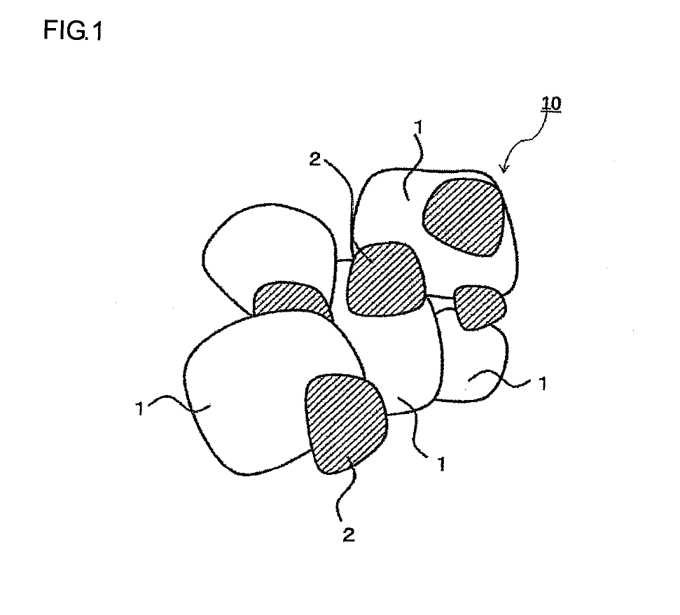

(FIG. 1)

It is a draw illustrating an example of the material for the negative plate according to the present invention.

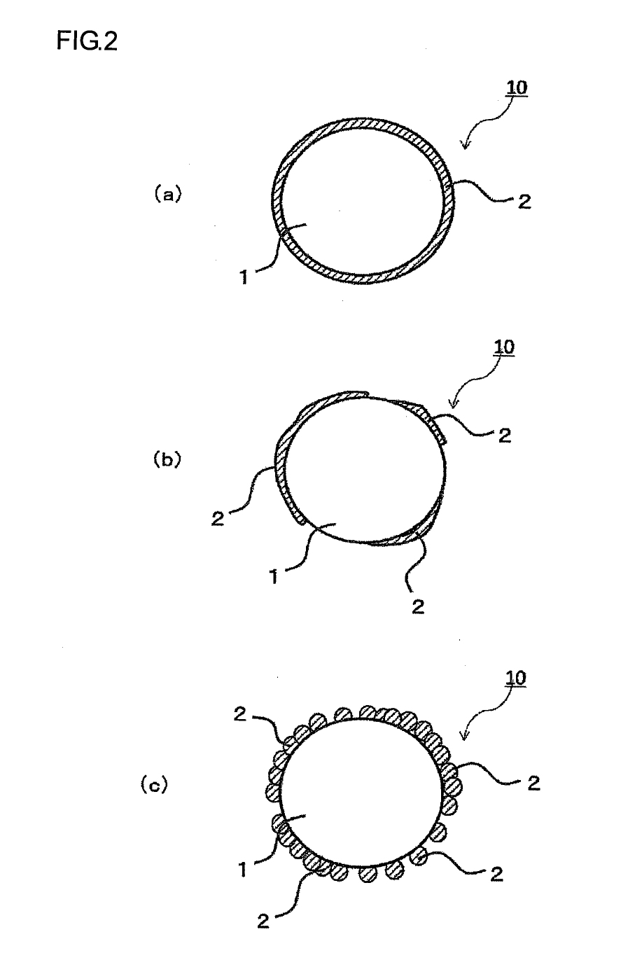

(FIG. 2)

It is a draw illustrating an example of the material for the negative plate according to the present invention.

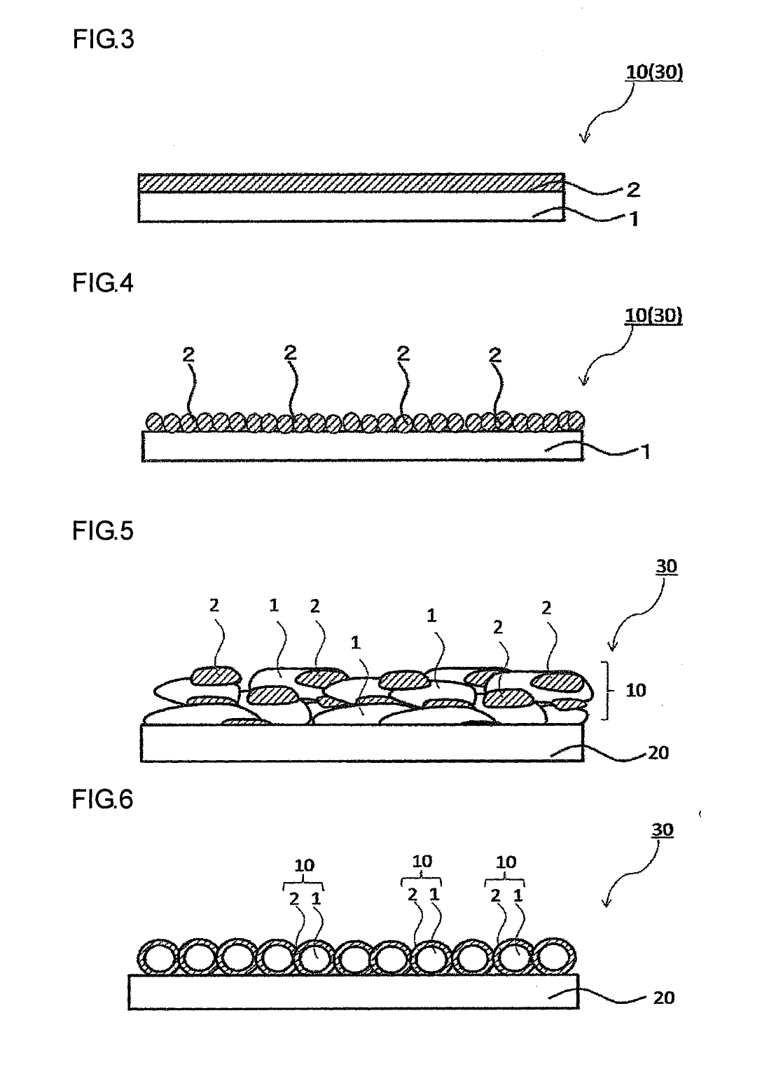

(FIG. 3)

It is a draw illustrating an example of the material for the negative plate according to the present invention.

(FIG. 4)

It is a draw illustrating an example of the material for the negative plate according to the present invention.

(FIG. 5)

It is a sectional view illustrating an example of the negative plate for the magnesium ion rechargeable battery according to the present invention.

(FIG. 6)

It is a sectional view illustrating an example of the negative plate for the magnesium ion rechargeable battery according to the present invention.

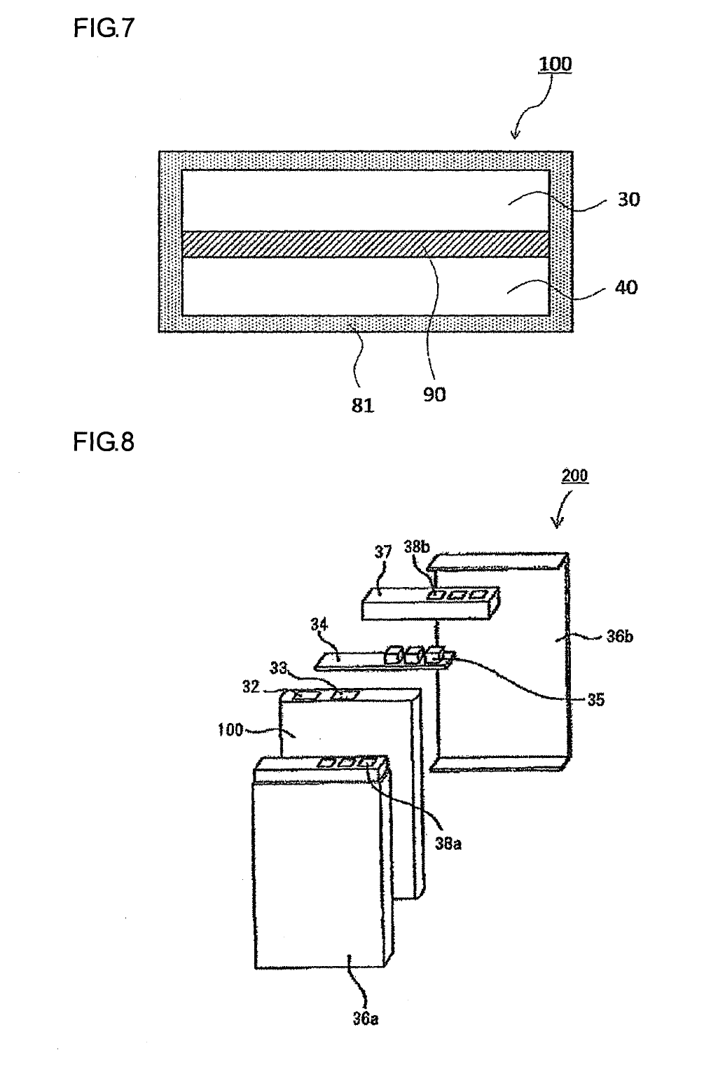

(FIG. 7)

It is a schematic view illustrating an example of the magnesium ion rechargeable battery according to the present invention.

(FIG. 8)

It is a sectional exploded view illustrating an example of the battery pack according to the present invention.

### EMBODIMENTS FOR CARRYING OUT THE INVENTION

Now, the material for the negative plate of the magnesium ion rechargeable battery according to the present invention will be explained with reference to the drawings.

### <Material for Negative Plate of Magnesium Ion Rechargeable Battery>

As shown in FIG. 1-FIG. 4, the material for the negative plate of the magnesium ion rechargeable battery according to the present invention contains magnesium metal and an allotrope of carbon, and the magnesium metal and the allotrope of carbon are in contact with each other at least in part. Hereinafter, the material for the negative plate of the magnesium ion rechargeable battery according to the present invention may be also referred as to “material for the negative plate” in some occasions.

In the present invention, by adopting the material which contains magnesium metal and an allotrope of carbon, and which takes a form in which the magnesium metal and the allotrope of carbon are in contact with each other at least in part, it becomes possible to charge and discharge electrically even in the case of using a liquid electrolyte which uses an aqueous type solvent by which the electrical charge and discharge has been said to be impossible in the prior art. Further, in the case of using as the electrolyte an electrolyte by which the electrical charge and discharge of the magnesium ion rechargeable battery is possible, such as an ethereal solution of Grignard reagent, etc., dramatic improvements in the cycle characteristic and the electrical charge and discharge efficiency can be expected. Although mechanisms to play these effects when using the material for the negative plate according to the present invention is not fully elucidated yet, it can be considered that the formation of oxide film onto the surface of the magnesium metal does not occur, or it is fully repressed in the case that the magnesium metal is in contact with the allotrope of carbon, and thereby, the above-mentioned superior effects would be brought. Moreover, in this case, it is assumed that the magnesium ions move along a route which passes through the electrolyte, the internal of the allotrope of carbon, contacting boundary, and the magnesium metal in this order, or along a route which passes through them in inverse order. Anyway, the domination of the material for the negative plate according to the present invention is clear, as it is seen from results of hereinafter described Examples and Comparative Examples.

The material for the negative plate according to the present invention only has to meet the requirement that it contains magnesium metal and an allotrope of carbon and the magnesium metal and the allotrope of carbon has come in contact with each other at least in part. For instance, the following four embodiments can be enumerated as the material for the negative plate according to the present invention.

### First Embodiment

In the material for the negative plate according to the first embodiment, both the magnesium metal and the allotrope of carbon take particulate forms, and the particulate magnesium metal 1 and the particulate allotrope of carbon are in contact with each other in part (See, FIG. 1).

In the material for the negative plate according to the present invention, as cases that the magnesium metal is in contact partially with the allotrope of the carbon, the following embodiments may be enumerated. As one embodiment, the embodiment where the magnesium metal is fixed directly to the allotrope of carbon, and, as a result, the magnesium metal and the allotrope of carbon has come in contact with each other in part, can be enumerated. This embodiment can be achieved by, for instance, fused bonding of the magnesium metal and the allotrope of carbon, and so on. As another embodiment, the embodiment where the magnesium metal is fixed to the allotrope of carbon via a binder or the like so as to the magnesium metal and the allotrope of carbon has come in contact with each other in part, can be enumerated. As the binder to be used, organic polymer compounds, such as, polyvinylidene fluoride; cellulose type polymer compounds, for instance, methyl cellulose and ethyl cellulose; and polyimide type polymer compound; and so on, can be exemplified.

The magnesium metal, that composes the material for the negative plate, may be magnesium metal element, per se. Alternatively, it may be a magnesium alloy. Herein, as the magnesium metal element, not only that of 100% in purity, but those which include inevitable impurities, are also involved. As the magnesium alloy, there is no particular limitation as far as it contains the magnesium metal as a main ingredient, and, for instance, alloys of magnesium and aluminum, alloys of magnesium and zinc, alloys of magnesium and aluminum and zinc, or alloys of magnesium and a metal other than the metals enumerated as above, can be enumerated. Herein, what is called as magnesium alloy means the one where the magnesium metal is contained as a main ingredient and the magnesium metal and other elements exist as the same phase. Regarding the content of the magnesium metal as the main ingredient, there is no particular limitation. Nevertheless, when the content of the magnesium metal is less than 80% by weight, a tendency where phases of other elements added to the magnesium metal exist independent of the phase of the magnesium metal may arise. Considering this point, therefore, it is preferable that the magnesium metal is contained in amount of not less than 80% by weight, based on the total weight of the magnesium alloy. This point is similarly adopted to the magnesium metal which is used for one of the second-fourth embodiments described hereinafter.

There is no particular limitation about the shape of the magnesium metal in the first embodiment, and, for instance, a squama shape, flat shape, spindle shape, and spheroidal shape may be used. Moreover, there is no especially limitation about the particle diameter of the magnesium metal, and it is possible to use as the magnesium metal the one of an arbitrary size which is selected properly under taking account of the thickness of the negative plate formed by using the material for the negative plate, and so on. In this embodiment, it is possible to use favorably the allotrope of the carbon having a mean diameter of about 0.1 μm-100 μm.

As the allotrope of the carbon to be in contact with the magnesium metal in part, there is no particular limitation. In the present invention, however, carbons having graphene structure, for instance, graphite such as natural graphite and artificial graphite, carbon nanotubes, fullerenes, and diamond-like carbons having graphene bonds, etc., may be preferably used. When such carbons having graphene structure is used, it is considered that the magnesium ions and the electrolyte can smoothly pass through the allotrope of carbon. More concretely, in the case that a liquid electrolyte using an aqueous solvent is adopted, although it is considered that the magnesium ions form complexes with the electrolyte and the aqueous solvent, it is considered that the magnesium ions as is in the form of the complexes can pass through the allotrope of carbon and reach the electrode so as to make transfer of electron possible.

Carbons other than the above-mentioned species, such as amorphous carbon, carbon black, carbon fibers, carbon nanofibers, etc., can be also used as the allotrope of carbon. Moreover, carbons which are obtained by heating organic polymer compounds at a temperature of more than the decomposition temperature of the organic polymer compounds can be also used. This point is similarly adopted to the allotropes of carbon which is used in the material for the negative plate in one of the second-fourth embodiments described hereinafter. Hereinafter, the allotropes of carbon may be also referred simply as to “carbon” as the generic name in some occasions.

There is no particular limitation about the shape of the carbon used in the first embodiment, and the one in the shape similar to the shape of the above-mentioned magnesium metal can be used. Moreover, there is no particular limitation about the particle diameter of the carbon, and it is possible to use as the carbon the one of an arbitrary size which is selected properly under taking account of the thickness of the negative plate formed by using the material for the negative plate, and so on. In this embodiment, it is possible to use favorably the carbon having a mean diameter of about 0.1 μm-50 μm.

The material for a negative plate according to the first embodiment is composed of at least one particulate magnesium metal and at least one particulate carbon. Incidentally, in the embodiment shown in FIG. 1, the material for a negative plate is composed of plurality of magnesium metal particulates and plurality of carbon particulates, and all of the magnesium metal particles which constitute the material for the negative plate are in contact with the carbon in part. However, the material for a negative plate according to the first embodiment is not limited to the embodiment shown in FIG. 1, and any constitution can be adopted as far as at least a part of magnesium metal in the magnesium metal particles which constitutes the material for the negative plate is in contact with the carbon.

### Second Embodiment

The material for the negative plate according to a second embodiment takes a constitution wherein at least a part of particulate magnesium metal is coated with filmy carbon or coated with particulate carbon in order that the magnesium metal is in contact with the carbon. That is, the material for the negative plate in the second embodiment is the one of having a core and shell construction. FIGS. 2(a), (b), and (c) are sectional views of the material for the negative plate to explain the core and shell construction.

As shown in FIG. 2(a), the filmy carbon may be fixed to the magnesium metal so as to cover the whole surface of the magnesium metal. Alternatively, as shown in FIG. 2(b), the filmy carbon may be fixed to the magnesium metal so as to be localized on the surface of the magnesium metal. Further, as shown in FIG. 2(c), it is possible to adopt an embodiment where the plural number of particular carbon are fixed, instead of the filmy carbon, on at least a part of surface of the magnesium metal. In any of these embodiments, at least a part of the surface of the magnesium metal is in contact with the carbon.

As cases that the magnesium metal is in contact partially with the allotrope of the carbon, a case where the whole surface of the magnesium metal is in contact with the allotrope of the carbon is also involved. For instance, in the case that the filmy carbon is fixed so as to cover the whole surface of the magnesium metal as shown in FIG. 2(a), namely, in the case that the whole surface of the magnesium metal is in contact with the allotrope of the carbon, it can be said that the magnesium metal and the allotrope of carbon has come in contact partially. In the case that the whole surface of the magnesium metal is covered with the filmy carbon, it is desirable that the filmy carbon possesses voids through which the electrolyte can pass. With respect to the point whether the filmy carbon has such voids, it can be confirmed by the scanning electron microscope (magnification: x10,000-x50,000).

Herein, when the filmy carbon to coat the magnesium metal is the one that has a graphene structure, for instance, such as graphite, it is not necessary that the filmy carbon possesses voids because it is thought that the electrolyte can pass between the graphene layers.

With respect to the point whether the carbon is contained in the material for the negative plate according to the second embodiment, it can be confirmed by element mapping shown on the elemental analysis in nano order with using the EDX detector onto a penetration type electron microscope according to the scanning penetration type electron microscope method.

The material for the negative plate in the form that the surface of the magnesium metal is covered with a filmy carbon (See, FIGS. 2(a) and (b)) can be prepared by dispersing or dissolving an organic polymer compound, which is able to become carbon when it is heated to a temperature of not less than the thermal decomposition temperature thereof, into a solvent; mixing the resultant with magnesium metal in order to prepare a solution where the organic polymer compound is mixed with the magnesium metal; and heating the solution to a temperature of not less than the thermal decomposition temperature of the organic polymer compound. Alternatively, it is also possible to utilize the vapor deposition method or the aerosol deposition method in order to form a film of carbon onto the surface of the magnesium metal. As the vapor deposition method, for instance, the physical vapor phase growth method and the chemical vapor phase growth method, etc. can be enumerated.

With respect to the organic polymer compound, it is desirable to select and to use the one of having less than 100 percent by weight in heating weight decrease rate at the decomposition initiating temperature of the transition metal compound to be used.

On the other hand, the material for the negative plate in the form that the surface of the magnesium metal is covered with the particulate carbon (See, FIG. 2(c)) can be prepared, for instance, by preparing a solution wherein the particulate magnesium metal, the particulate carbon and a binder are dispersed or dissolved in a solvent; and heating the solution. As the binder, organic polymer compounds, such as polyvinylidene fluoride, etc., can be enumerated.

### Third Embodiment

In the material for the negative plate according to the third embodiment, a film of carbon is provided onto a substrate 1 of magnesium metal, and thus, the magnesium metal is in contact with the carbon (See, FIG. 3). According to the third embodiment, it is possible to use the as-is form of the material for the negative plate as the negative plate.

As the substrate 1 of the magnesium metal, magnesium metallic foil, etc., can be used. It is desirable that the thickness of substrate 1 of the magnesium metal is in the range of 10-100 μm, and more desirably, in the range of 10-50 μm, although there is no particular limitation about the thickness of substrate 1 of the magnesium metal.

The material for the negative plate according to the third embodiment can be prepared by, for instance, preparing a solution wherein an organic polymer compound as previously explained in the above-mentioned second embodiment, as well as a binder if desired, are dispersed or dissolved in a solvent, coating the solution onto the substrate of the magnesium metal, and heating the coated substrate to a temperature of not less than the thermal decomposition temperature of the organic polymer compound.

Alternatively, it is also possible to utilize the vapor deposition method or the aerosol deposition method in order to form a film of carbon onto the surface of the substrate made of the magnesium metal. As examples of vapor deposition method, the same methods as previously explained in the above-mentioned second embodiment can be applied as-is.

With respect to the thickness of the film of the carbon, it is desirable that the thickness in dried state is in the range of about 0.1-5 μm, although there is no particular limitation about the thickness of the film of the carbon.

### Fourth Embodiment

In the material for the negative plate according to the fourth embodiment, a plural number of particulate carbon 2 are provided on a substrate 1 of the magnesium metal, and thus, the magnesium metal in the form of substrate 1 is in contact with the carbon in the form of particles 2 (See, FIG. 4). According to the fourth embodiment, it is possible to use the as-is form of the material for the negative plate as the negative plate, as is the case with the third embodiment.

As the substrate 1 of the magnesium metal, it is possible to use the one used in the above-mentioned third embodiment in an analogous fashion, and the explanation about it is omitted here.

As the particulate carbon, it is possible to use the one explained in the above-mentioned first embodiment in an analogous fashion, and the explanation about it is omitted here.

The material for the negative plate according to the fourth embodiment can be prepared by, for instance, preparing a coating solution in which the particulate carbon, such as graphite particles, and a binder are dispersed or dissolved in an appropriate solvent; coating the coating solution onto the surface of the substrate of the magnesium metal, and then drying it. As the binder, organic polymer compounds, such as polyvinylidene fluoride, etc., can be enumerated.

As previously described, in the case that the magnesium metal is in contact with the allotrope of carbon, it is considered that the formation of oxide film onto the surface of the magnesium metal does not occur, or it is fully repressed, and thereby, the above-mentioned superior effects would be brought. Moreover, in this case, it is assumed that the magnesium ions move along a route which passes through the electrolyte, the internal of the allotrope of carbon, contacting boundary, and the magnesium metal in this order, or along a route which passes through them in inverse order. Therefore, it is desirable in all the cases in the above-mentioned first to fourth embodiments that a ratio of the area of the part where the magnesium metal is in contact with the carbon to the surface area of the magnesium metal becomes larger. Concretely, it is desirable that the area of the part where the magnesium metal is in contact with the carbon is not less than 10%, on the basis of the surface area of the magnesium metal, and it is particularly desirable to be not less than 40%. Herein, the surface area of the magnesium metal means the total area of the area of the part where the magnesium metal is in contact with the carbon and the area of part where the magnesium metal is in contact with electrolyte, among the whole surface of the magnesium metal.

As methods for enlarging the contacting area with the carbon, various methods can be adopted, and, for instance, in the case that the particulate carbon is used, it is possible to enlarge the contacting area by pressing a product after contacting the magnesium metal with the carbon. In the case that the filmy carbon is used, it is possible to enlarge the contacting area by increasing the coating area. Incidentally, the contacting area can be confirmed by using the scanning electron microscope.

With respect to the material for the negative plate, the explanations about the essential components of the magnesium metal, and the carbon, as well as an optional component of the binder have been made as above. The material for the negative plate according to the present invention, however, may contains other components, for instance, a electroconductive material, such as electroconductive polymer, other metallic material, electroconductive ceramics, etc., and/or a modifier, such as, catalyst, etc.

### <Negative Plate for Magnesium Ion Rechargeable Battery>

The negative plate for the magnesium ion rechargeable battery is a negative plate for which the material for the negative plate of the magnesium ion rechargeable battery as described above is used. In the present invention, the following embodiments are taken according to the material for the negative plate of the first to the fourth embodiment described as above. Hereafter, the negative plate for the magnesium ion rechargeable battery according to the present invention may be also referred simply as to “the negative plate according to the present invention” in some occasions.

The first embodiment of the negative plate 30 according to the present invention is an embodiment where the material for the negative plate according to the present invention is provided on a supporting substrate 20, as shown in FIG. 5 and FIG. 6. Concretely, in this embodiment, the material for the negative plate according to the above-mentioned first embodiment, or the material for the negative plate according to the above-mentioned second embodiment is provided on the supporting substrate 20. Herein, FIG. 5 is a sectional view illustrating a negative plate where the material 10 for the negative plate according to the first embodiment is provided on the supporting substrate 20, and FIG. 6 is a sectional view illustrating a negative plate where the material 10 for the negative plate according to the second embodiment is provided on the supporting substrate 20.

As the supporting substrate 20 for supporting the material 10 for the negative plate according to the first embodiment or the second embodiment, for instance, aluminum substrate, nickel substrate, magnesium substrate, titanium substrate, copper substrate, carbon board, etc. can be enumerated.

With respect to the thickness of the supporting substrate 20, it is desirable to be in the range of about 10-100 μm, and more preferably, in the range of about 10-50 μm, although the although the thickness of the supporting substrate is not particular limited thereto.

The negative plate as shown in FIG. 5 and FIG. 6 can be manufactured by preparing a coating solution in which the material 10 for the negative plate of the present invention, and an optionally added binder are dissolved in an appropriate solvent; coating the coating solution onto the supporting substrate 20, and then drying it.

In the above mentioned embodiments, the material for the negative plate according to the first embodiment or the second embodiment is supported with using the supporting substrate 20. However, a certain support can be given to the material for the negative plate in the first embodiment or the material for the negative plate in the second embodiment, for instance, by pressing the material for the negative plate in the first embodiment or the material for the negative plate in the second embodiment. In this case, it is possible to use as the negative plate an article which is manufactured by pressing the material for the negative plate in the first embodiment or the material for the negative plate in the second embodiment as it is, without using the supporting substrate 20 as shown in FIG. 5 or FIG. 6.

The second embodiment of the negative plate according to the present invention is an embodiment where the as-is form of the material for the negative plate according to the third embodiment, or, the as-is form of the material for the negative plate according to the fourth embodiment, namely, the as-is form of the material 10 for the negative plate where the carbon 2 is provided on the substrate 20 of magnesium metal (See, FIG. 3 and FIG. 4), is used as the negative plate 30. In this embodiment, the substrate of the magnesium metal also functions as a supporter.

In addition, the negative plate for the magnesium ion rechargeable battery according to the present invention can take various modified embodiments besides the constitutions as mentioned above. For instance, as a negative plate according to a modified embodiment, a separator integral type negative plate can be enumerated. With respect to the separator integral type negative plate, for instance, a constitution where a separator is further provided on the allotrope of the carbon, such as the filmy carbon or plural number of carbon particles, which is provided on the substrate of the magnesium metal can be enumerated.

Herein, in the case that the allotrope of the carbon, such as the filmy carbon or plural number of carbon particles, is provided on the substrate of magnesium metal as well as on a separator, and the substrate of magnesium metal has come in contact with the allotrope of the carbon provided on the separator in part, for example, the substrate of magnesium metal has come in contact with the filmy carbon or plural number of carbon particles provided on the separator in part within a magnesium ion rechargeable battery, it can be said that the negative plate according to the present invention, that is, the separator integral type negative plate according to the above-mentioned modified embodiment exists in the magnesium ion rechargeable battery.

### <Magnesium Ion Rechargeable Battery>

Next, the magnesium ion rechargeable battery according to the present invention will be explained with reference to FIG. 7. FIG. 7 is a schematic view illustrating an example of the magnesium ion rechargeable battery 100 according to the present invention. As shown in FIG. 7, the magnesium ion rechargeable battery according to the present invention takes a constitution in which the magnesium ion rechargeable battery comprises a positive plate 40, a negative plate 30 which is used in combination with the positive plate; and the positive and negative plates are installed in a container which is composed of an outer casing 81; and the container is sealed on condition that an electrolyte 90 is filled in the container.

Herein, the magnesium ion rechargeable battery 100 according to the present invention is characterized in the point that the negative plate 30 is the above-mentioned negative plate according to the present invention. Concretely, it is the one characterized in the point that the negative plate which comprises the material 10 for a negative plate according to the present invention wherein the magnesium metal and an allotrope of carbon are in contact with each other at least in part is used to be an indispensable component. As far as this requirement is satisfied, there is no particular limitation about other requirements with respect to the magnesium ion rechargeable battery 100 according to the present invention. Therefore, with respect to the positive plate, the electrolyte, and the container, it is possible to use those which are well-known in the field of the magnesium ion rechargeable battery so far, with making appropriately selections, and thus, the magnesium ion rechargeable battery according to the present invention is not limited to the embodiment shown in FIG. 7. As the negative plate, it is possible to use the one described above as the negative plate according to the present invention as is, and the explanation about it is omitted here.

The positive plate 40 is usually composed of a positive pole substrate, and a material for positive plate which is provided on the positive pole substrate. As the positive pole substrate, for instance, aluminum plate, copper plate, titanium plate, nickel plate, stainless steel plate, etc., each having about 10-100 μm in thickness can be enumerated.

As the material for positive plate, it is possible to use any material capable of carrying out the reversible insertion and desorption of the magnesium ions. For instance, as such a material for positive plate, graphite fluoride ((CF)₀), manganese oxides such as manganese dioxide (MnO₂), vanadium oxides such as vanadium pentaoxide (V₂O₅), etc., can he enumerated.

There is no particular limitation about the electrolyte 90 to be used, and it is possible to use an electrolyte which uses an aqueous solvent or an organic solvent, an ionic liquid, a solid electrolyte, a gel electrolyte, etc.

As examples of the electrolyte, the electrolytes which are known as the one capable of carrying out the reversible insertion and desorption of the magnesium ions, for instance, an ethereal solution of Grignard reagent (RMgX: wherein R represents an alkyl group or an aryl group, Mg represents magnesium, and X represents one of iodine, bromine or chlorine), a solution in which magnesium, bis(trifluoro methane sulfonyl) imide (Mg(TFSI)₂) is dissolved in propylene carbonate or dimethoxy ethane solvent, are enumerated. According to the magnesium ion rechargeable battery 100 of the present invention, in combination with such an electrolyte, an improvement in the electrical charge and discharge efficiency and an improvement in the cycle characteristic, as compared with the case of using the negative plate known in the art, can be expected.

Moreover, according to the present invention, it becomes possible to charge and discharge electrically even in the case of using a liquid electrolyte which uses an aqueous type solvent and by which the electrical charge and discharge has been said to be impossible in the prior art, for instance, an electrolyte in which magnesium nitrate is dissolved in an solvent such as water, or an electrolyte in which lithium nitrate is dissolved in an solvent such as water.

With respect to the structure of the magnesium ion battery which is manufactured by using a positive plate, the negative plate 30 according to the present invention, and an electrolyte 90, it is possible to use any structure known in the art by selecting appropriately. For instance, a structure in which the positive plate and the negative plate and a separator located therebetween (not shown in figure), such as a porous film made of polyethylene, are wound spirally in order to store them in a battery's container, is enumerated. As another embodiment, it is possible to adopt a structure in which positive plates and negative plates, both of which have been cut out to a prescribed shape, are stacked alternately while interposing a separator between the individual positive plate and negative plate, and the stacked form is fixed in order to store it in a in a battery's container. In each structure, in order to manufacture a magnesium ion rechargeable battery, lead wires attached to the positive plates are connected to a positive pole terminal which is provided on the outer casing, while lead wires attached to the negative plates are connected to a negative pole terminal which is provided on the outer casing, and the battery's container is filled with the electrolyte 90, and thereafter, the battery's container is sealed. Herein, when using as the electrolyte 90 a solid electrolyte, a gel electrolyte, or the like, it is possible to omit the separators.

### (Battery Pack)

Next, the battery pack 200 which is composed by using the magnesium ion rechargeable battery 100 according to the present invention will be explained with reference to FIG. 8. FIG. 8 is a sectional exploded view illustrating an example of the battery pack 200 according to the present invention.

As shown in FIG. 8, the battery pack 200 is assembled by storing the magnesium ion rechargeable battery 100 in a resin case 36a, an resin case 36b, and an edge case 37. In addition, a protection circuit board 34 to prevent over-charge and over-discharge is interposed between the face, which is equipped with the positive pole terminal 32 and the negative pole terminal 33 and which is a side face of the magnesium ion rechargeable battery, and the edge case 37.

The protection circuit board 34 is equipped with an externally connecting connector 35, and the externally connecting connector 35 is inserted into a window 38a for the external connection which is provided in the resin case 36a, and inserted into a window 38b for the external connection which is provided in the edge case 37 in order to be connected with an external terminal. In addition, the protection circuit board 34 is equipped with a charge and discharge safety circuit for controlling charge and discharge, a wiring circuit for electrically connecting the external terminal with the magnesium ion rechargeable battery 100, both of which are not shown in the figure.

The battery pack 200 may adopt any structure of the battery pack known in the art by selecting appropriately, excluding the point that the magnesium ion rechargeable battery 100 according to the present invention should be used. The battery pack 200 may be equipped optionally with a positive pole lead board to be connected to the positive pole terminal 32, a negative pole lead board to be connected to the negative pole terminal 33, an insulator, etc., which are interposed between the magnesium ion rechargeable battery 100 and the edge case 37, although they are not shown in the figure.

Incidentally, the magnesium ion rechargeable battery 100 according to the present invention may be used in an embodiment other than the above-mentioned embodiment of the use in the battery pack, wherein the above-mentioned protection circuit further possesses functions, such as breaking of over-current, monitoring of the temperature of the battery, etc., and such a protection circuit is mounted on and integrated with the magnesium ion rechargeable battery 100. In such an embodiment, it is possible to use the product per se as a magnesium ion rechargeable battery equipped with the protection function and the protection circuit, without constructing a battery pack, and thus, it owns a high general versatility. Herein, it would be understood that the above-mentioned embodiments are described only for the purpose of explaining the present invention, and these embodiments are not limited to the use of the negative plate 30 according to the present invention and the use of the magnesium ion rechargeable battery 200 according to the present invention at all.

### EXAMPLES

Next, the present invention will be described more concretely by it explains the present invention more concretely by enumerating Examples and Comparative Examples. Hereinafter, the representation of “part” or “percentage” means those based on weight, unless mentioning contrary.

### Example 1

### Preparation of Positive Plate 1;

Manganese oxide (MnO₂): 10 g and acetylene black: 1 g, 10% of polyvinyiidene fluoride (PVDF) (manufactured by KUREHA Corporation, and marketed under a trade name of KF #1100) in n-methyl pyrrolidone (NMP) solvent (manufactured by Mitsubishi Chemical Corporation): 10 g were mixed, and stirred by EXCEL AUTO HOMOGENIZED (manufactured by NIHONSEIKI KAISHA LTD.) at a rotational rate of 4000 rpm for 5 minutes in order to obtain an ink for positive plate 1. This ink was spread on an aluminum substrate having 15 μm in thickness with an applicator having a gap of 200 μm, then, it dried at 150° C., and the resultant underwent pressing with 2 tons/cm in order to obtain the positive plate 1.

### Preparation of Negative Plate 1;

Graphite particles (CGC50, manufactured by Nippon Graphite Industries, Ltd., mean particle diameter: 5 μm): 10 g, 10% of PVDF (manufactured by KUREHA Corporation, and marketed under a trade name of KF #1100) in n-methyl pyrrolidone (NMP) solvent (manufactured by Mitsubishi Chemical Corporation): 10 g were mixed, and stirred by EXCEL AUTO HOMOGENIZES (manufactured by NIHONSEIKI KAISHA LTD.) at a rotational rate of 4000 rpm for 5 minutes in order to obtain an ink for negative plate 1. This ink was spread on a magnesium alloy (containing 3% aluminum and 1% zinc) substrate having 45 μm in thickness with an applicator having a gap of 200 μm, then, it dried at 100° C., in order to obtain the negative plate 1.

### Preparation of Electrolyte 1;

Electrolyte 1 was prepared by dissolving magnesium nitrate hexahydrate to water so as to be a concentration of 1 mol/L.

### Manufacturing of Three Pole Type Coin Cell 1;

Three pole type coin cell 1 of Example 1 was assembled by using the positive plate 1 prepared as above as a working electrode, the negative plates 2 prepared as above as a counter electrode plate and a reference electrode plate, and the electrolyte 1 prepared as above as an electrolyte.

### Example 2

### Preparation of Negative Plate 2;

The above-mentioned ink for negative plate 1 was spread on a magnesium alloy (containing 3% aluminum and 1% zinc) substrate having 45 μm in thickness with an applicator having a gap of 200 μm, then, it dried at 100° C., and the resultant underwent pressing with 2 tons/cm in order to obtain the negative plate 2.

### Preparation of Electrolyte 2;

Electrolyte 2 was prepared by dissolving magnesium bis(trifluoro methane sulfonyl)imide (Mg(TFSI)₂) to water so as to be a concentration of 0.5 mol/L.

### Manufacturing of Three Pole Type Coin Cell 2;

Three pole type coin cell 2 of Example 2 was assembled by using the positive plate 1 used in Example 1 as a working electrode, the negative plates 2 prepared as above as a counter electrode plate and a reference electrode plate, and the electrolyte 2 prepared as above as a electrolyte.

### Example 3

### Preparation of Electrolyte 3;

Electrolyte 3 was prepared by dissolving magnesium bis(trifluoro methane sulfonyl)imide (Mg(TFSI)₂) to dimethoxy ethane solvent so as to be a concentration of 0.5 mol/L.

### Manufacturing of Three Pole Type Coin Cell 3;

Three pole type coin cell 3 of Example 3 was assembled by using the positive plate 1 used in Example 1 as a working electrode, the negative plates 2 used in Example 2 as a counter electrode plate and a reference electrode plate, and the electrolyte 3 prepared as above as a electrolyte.

### Example 4

### Preparation of Negative Plate 3;

Magnesium metal particles (mean particle diameter: 15 μm): 5 g, graphite particles (CGC50, manufactured by Nippon Graphite Industries, Ltd., mean particle diameter: 5 μm): 5 g, 3% of methyl cellulose in water solvent: 30 g were mixed, and stirred by EXCEL AUTO HOMOGENIZER (manufactured by NIHONSEIKI KAISHA LTD.) at a rotational rate of 4000 rpm for 5 minutes in order to obtain an ink for negative plate 3. This ink was spread on a copper substrate having 10 μm in thickness with an applicator having a gap of 100 μm, then, it dried at 100° C., and the resultant underwent pressing with 2 tons/cm in order to obtain the negative plate 3.

### Preparation of Electrolyte 4;

Electrolyte 4 was prepared by dissolving magnesium nitrate hexahydrate to n-methyl pyrrolidone (NMP) solvent so as to be a concentration of 1 mol/L.

### Manufacturing of Three Pole Type Coin Cell 4;

Three pole type coin cell 4 of Example 4 was assembled by using the positive plate 1 used in Example 1 as a working electrode, the negative plates 3 prepared as above as a counter electrode plate and a reference electrode plate, and the electrolyte 4 prepared as above as an electrolyte.

### Example 5

### Preparation of Positive Plate 2;

Vanadium pentoxide (V₂O₅): 10 g, acetylene black: 1 g, 10% of PVDF (manufactured by KUREHA Corporation, and marketed under a trade name of KF #1100) in n-methyl pyrrolidone (NMP) solvent (manufactured by Mitsubishi Chemical Corporation): 10 g were mixed, and stirred by EXCEL AUTO HOMOGENIZER (manufactured by NIHONSEIKI KAISHA LTD.) at a rotational rate of 4000 rpm for 5 minutes in order to obtain an ink for positive plate 2. This ink was spread on an aluminum substrate having 15 μm in thickness with an applicator having a gap of 200 μm, then, it dried at 150° C., and the resultant underwent pressing with 2 tons/cm in order to obtain the positive plate 2.

### Manufacturing of Three Pole Type Coin Cell 5;

Three pole type coin cell 5 of Example 5 was assembled by using the positive plate 2 prepared as above as a working electrode, the negative plates 2 used in Example 2 as a counter electrode plate and a reference electrode plate, and the electrolyte 3 prepared in Example 3 as an electrolyte.

### Example 6

### Preparation of Negative Plate 4;

Graphite particles (CGC50, manufactured by Nippon Graphite Industries, Ltd., mean particle diameter: 5 μm): 10 g, 10% of PVDF (manufactured by KUREHA Corporation, and marketed under a trade name of KF #1100) in n-methyl pyrrolidone (NMP) solvent (manufactured by Mitsubishi Chemical Corporation): 10 g were mixed, and stirred by EXCEL AUTO HOMOGENIZER (manufactured by NIHONSEIKI KAISHA LTD.) at a rotational rate of 4000 rpm for 5 minutes in order to obtain an ink for negative plate 4. This ink was spread on a magnesium (magnesium purity: 99.9%, manufactured by NIPPON KINZOKU CO., LTD.) substrate having 45 μm in thickness with an applicator having a gap of 200 μm, then, it dried at 100° C., in order to obtain the negative plate 4.

### Preparation of Electrolyte 5;

Electrolyte 5 was prepared by dissolving magnesium nitrate hexahydrate to γ-butyrolactone solvent so as to be a concentration of 1 mol/L.

### Manufacturing of Three Pole Type Coin Cell 6;

Three pole type coin cell 6 of Example 6 was assembled by using the positive plate 2 used in Example 5 as a working electrode, the negative plates 4 prepared as above as a counter electrode plate and a reference electrode plate, and the electrolyte 5 prepared as above as an electrolyte.

### Example 7

### Preparation of Negative Plate 5;

The same procedure as in Example 6 for preparation of the negative plate 4 was repeated except that the magnesium (magnesium purity: 99.9%, manufactured by NIPPON KINZOKU CO., LTD.) substrate having 45 μm in thickness was replaced with a magnesium alloy (containing 4% iron, manufactured by NIPPON KINZOKU CO., LTD.) substrate having 45 μm in thickness, in order to obtain the negative plate 5.

### Manufacturing of Three Pole Type Coin Cell 7;

Three pole type coin cell 7 of Example 7 was assembled by using the positive plate 2 used in Example 5 as a working electrode, the negative plates 5 prepared as above as a counter electrode plate and a reference electrode plate, and the electrolyte 5 prepared in Example 6 as an electrolyte.

### Example 8

### Preparation of Negative Plate 6;

Graphite particles (CPB, manufactured by Nippon Graphite Industries, Ltd., mean particle diameter: 10 μm): 10 g, 10% of PVDF (manufactured by KUREHA Corporation, and marketed under a trade name of KF #1100) in n-methyl pyrrolidone (NMP) solvent (manufactured by Mitsubishi Chemical Corporation): 10 g were mixed, and stirred by EXCEL AUTO HOMOGENIZER (manufactured by NIHONSEIKI KAISHA LTD.) at a rotational rate of 4000 rpm for 5 minutes in order to obtain an ink for negative plate 6. This ink was spread on a magnesium alloy (containing 3% aluminum and 1% zinc) substrate having 45 μm in thickness with an applicator having a gap of 200 μm, then, it dried at 100° C. in order to obtain the negative plate 6.

### Manufacturing of Three Pole Type Coin Cell 8;

Three pole type coin cell 8 of Example 8 was assembled by using the positive plate 2 used in Example 5 as a working electrode, the negative plates 6 prepared as above as a counter electrode plate and a reference electrode plate, and the electrolyte 5 prepared in Example 6 as an electrolyte.

### Example 9

### Preparation of Negative Plate 7;

The same procedure as in Example 8 for preparation of the negative plate 6 was repeated except that the graphite particles (CPB, manufactured by Nippon Graphite Industries, Ltd., mean particle diameter: 10 μm): 10 g was replaced with carbon fibers (VGCF, manufactured by Showa Denko K.K., fiber diameter: 150 nm, and fiber length: 10-20 μm): 10 g, in order to obtain the negative plate 7.

### Manufacturing of Three Pole Type Coin Cell 3;

Three pole type coin cell 9 of Example 9 was assembled by using the positive plate 2 used in Example 5 as a working electrode, the negative plates 7 prepared as above as a counter electrode plate and a reference electrode plate, and the electrolyte 5 prepared in Example 6 as an electrolyte.

### Example 10

### Preparation of Negative Plate 8;

The same procedure as in Example 8 for preparation of the negative plate 6 was repeated except that the graphite particles (CPB, manufactured by Nippon Graphite Industries, Ltd., mean particle diameter: 10 μm): 10 g was replaced with acetylene black (AB powder, manufactured by DENKI KAGAKU KOGYO KABUSHIKI KAISHA): 10 g, in order to obtain the negative plate 8.

### Manufacturing of Three Pole Type Coin Cell 10;

Three pole type coin cell 10 of Example 10 was assembled by using the positive plate 2 used in Example 5 as a working electrode, the negative plates 8 prepared as above as a counter electrode plate and a reference electrode plate, and the electrolyte 5 prepared in Example 6 as an electrolyte.

### Example 11

### Preparation of Negative Plate 3;

The same procedure as in Example 6 for preparation of the negative plate 4 was repeated except that the graphite particles (CGC50, manufactured by Nippon Graphite Industries, Ltd., mean particle diameter: 5 μm): 5 g was replaced with graphite particles (CGB20, manufactured by Nippon Graphite Industries, Ltd., mean particle diameter: 15 μm): 10 g, and the magnesium (magnesium purity: 99.9%, manufactured by NIPPON KINZOKU CO., LTD.) substrate having 45 μm in thickness was replaced with a magnesium alloy (containing 4% nickel, manufactured by NIPPON KINZOKU CO., LTD.) substrate having 45 μm in thickness, in order to obtain the negative plate 9.

### Preparation of Electrolyte 6;

Electrolyte 6 was prepared by dissolving magnesium bis(trifluoro methane sulfonyl)imide (Mg(TFSI)₂) to ethylene glycol (EG) solvent so as to be a concentration of 0.25 mol/L.

### Manufacturing of Three Pole Type Coin Cell 11;

Three pole type coin cell 11 of Example 11 was assembled by using the positive plate 2 used in Example 5 as a working electrode, the negative plates 9 prepared as above as a counter electrode plate and a reference electrode plate, and the electrolyte 6 prepared as above as an electrolyte.

### Example 12

### Preparation of Negative Plate 10;

The same procedure as in Example 8 for preparation of the negative plate 6 was repeated except that the graphite particles (CPB, manufactured by Nippon Graphite Industries, Ltd., mean particle diameter: 10 μm): 10 g was replaced with graphite particles (CGB20, manufactured by Nippon Graphite Industries, Ltd., mean particle diameter: 15 μm): 10 g, in order to obtain the negative plate 10.

### Manufacturing of Three Pole Type Coin Cell 12;

Three pole type coin cell 12 of Example 12 was assembled by using the positive plate 2 used in Example 5 as a working electrode, the negative plates 10 prepared as above as a counter electrode plate and a reference electrode plate, and the electrolyte 6 prepared in Example 11 as an electrolyte.

### Example 13

### Preparation of Negative Plate 11;

The same procedure as in Example 8 for preparation of the negative plate 6 was repeated except that the graphite particles (CGC50, manufactured by Nippon Graphite Industries, Ltd., mean particle diameter: 5 μm): 10 g was replaced with graphite particles (UTC16, manufactured by Nippon Graphite Industries, Ltd., mean particle diameter: 20 μm): 10 g, in order to obtain the negative plate 11.

### Manufacturing of Three Pole Type Coin Cell 13;

Three pole type coin cell 13 of Example 13 was assembled by using the positive plate 2 used in Example 5 as a working electrode, the negative plates 11 prepared as above as a counter electrode plate and a reference electrode plate, and the electrolyte 6 prepared in Example 11 as an electrolyte.

### Example 14

### Preparation of Negative Plate 12;

The same procedure as in Example 8 for preparation of the negative plate 6 was repeated except that the graphite particles (CGC50, manufactured by Nippon Graphite Industries, Ltd., mean particle diameter: 5 μm): 10 g was replaced with carbon fibers (VGCF, manufactured by Showa Denko K.K., fiber diameter: 150 nm, and fiber length: 10-20 μm): 10 g, in order to obtain the negative plate 12.

### Manufacturing of Three Pole Type Coin Cell 14;

Three pole type coin cell 14 of Example 14 was assembled by using the positive plate 2 used in Example 5 as a working electrode, the negative plates 12 prepared as above as a counter electrode plate and a reference electrode plate, and the electrolyte 6 prepared in Example 11 as an electrolyte.

### Comparative Example 1

The same procedure as in Example 1 for preparation of the negative plate 1 was repeated except that the addition of graphite particles (mean particle diameter: 5 μm): 10 g was omitted, in order to obtain the negative plate A.

### Manufacturing of Three Pole Type Coin Cell A;

Three pole type coin cell A of Comparative Example 1 was assembled by repeating the same procedure as in Example 1 except that the negative plate 1 was replaced with the negative plate A.

### Comparative Example 2

The same procedure as in Example 2 for preparation of the negative plate 2 was repeated except that the addition of graphite particles (mean particle diameter: 5 μm): 10 g was omitted, in order to obtain the negative plate B.

### Manufacturing of Three Pole Type Coin Cell A;

Three pole type coin cell B of Comparative Example 2 was assembled by repeating the same procedure as in Example 2 except that the negative plate 2 was replaced with the negative plate B.

### Comparative Example 3

### Manufacturing of Three Pole Type Coin Cell C;

Three pole type coin cell C of Comparative Example 3 was assembled by repeating the same procedure as in Example 3 except that the negative plate 2 was replaced with the negative plate B.

### Comparative Example 4

### Manufacturing of Three Pole Type Coin Cell D;

Three pole type coin cell D of Comparative Example 4 was assembled by repeating the same procedure as in Example 5 except that the negative plate 2 was replaced with the negative plate B.

When comparing Example 1 with Comparative Example 1, comparing Example 2 with Comparative Example 2, comparing Example 3 with Comparative Example 3, and, comparing Example 5 and Comparative Example 4; they differed only in a point that the negative plate of each Example contained an individual material for negative plate which contained magnesium metal and an allotrope of carbon, and the magnesium metal and the allotrope of carbon were in contact with each other in part, while the negative plate of each Comparative Example did not contain an allotrope of carbon; and they overlapped each other in the other points. Further, in Examples 6-14, graphites having different crystallinities, or allotropes of carbon other than graphite were used.

### Electrical Charge and Discharge Test;

Electrical charge and discharge test was done for each three pole type coin cell of Examples and Comparative Examples.

The electrical charge and discharge test was performed within the following voltage range in order to confirm whether the electrical charge and discharge by using each three pole type coin cell of Examples and Comparative Examples was possible or not. In each case, the current were passed at 30 μA/cm². Concretely, electricity was discharged to the lower limit voltage in the following voltage range as the first electrical discharge test; and then, electricity was charged up to the upper limit value in the following voltage range, which was followed by discharging to the lower limit voltage in the following voltage range as an electrical charge and discharge test of the second cycle. For instance, with respect to the evaluation of Example 1 and Comparative Example 1, electricity was discharged to 0.5 V as the first electrical discharge test, and electricity was charged up to 1.5 V and then discharged to 0.5 V as the electrical charge and discharge test of the second cycle.

Thereafter, additional charges and discharges within the following voltage range were repeated with respect to Examples 2-14 and Comparative Examples 2-4. This repetition was continued up to 20th cycle at maximum, assuming that the first discharge was the first electrical discharge test, and the charge and discharge thereafter was the electrical charge and discharge test of a second cycle. For instance, with respect to the evaluation of Example 2 and Comparative Example 2, electricity was discharged to 0.4 V as the first electrical discharge test, and electricity was charged up to 1.8 V and then discharged to 0.4 V as the electrical charge and discharge test of the second cycle, and this electrical charge and discharge test was repeated up to the 20th cycle.

### Example 1 and Comparative Example 1

voltage range 0.5V-1.5V

### Example 2 and Comparative Example 2

voltage range 0.4V-1.8V

### Example 3 and Comparative Example 3

voltage range 0.4V-1.7V

Example 4 voltage range 0.5V-1.4V

### Example 5 and Comparative Example 4

voltage range 0.4V-1.5V

Examples 6-14 voltage range 0.3V-1.8V

With respect to the three pole type coin cell of Example 1, it was possible to perform the charge and discharge of the second cycle. On the other hand, with respect to the three pole type coin cell of Comparative Example 1, it was impossible to perform the charge and discharge of the second cycle.

Herein, the three pole type coin cells of Example 1 and Comparative Example 1 differed only in a point that the negative plate of the three pole type coin cell of Example 1 contained graphite particles, and the graphite particles were in contact with the magnesium alloy plate, while the negative plate of the three pole type coin cell of Comparative Example 1 did not contain graphite particles.

With respect to the three pole type coin cell of Example 2, the improvement in the cycle characteristic was confirmed, as compared with the three pole type coin cell of Comparative Example 2. Similarly, with respect to the three pole type coin cell of Example 3, the improvement in the cycle characteristic was confirmed, as compared with the three pole type coin cell of Comparative Example 3. Herein, the representation of “cycle characteristic” means an evaluation based on the discharge capacity rate which is calculated by dividing the discharge capacity after fast discharge (mAhr/g) by the discharge capacity after a certain prescribed cycle's discharge (mAhr/g) and then multiplying by 100. When data of the charge and discharge capacity rate on a certain prescribed cycle are compared, the higher the value of the charge and discharge capacity rate becomes, the more the cycle characteristic is superior. Herein, the evaluation of the cycle characteristic between Example 2 and Comparative Example 2, and the evaluation of the cycle characteristic between Example 3 and Comparative Example 3, were performed based on the data of the discharge capacity rate after the second cycle's discharge. The discharge capacity is a value which is obtained by performing constant-current discharge at a discharge rate 1 C, drawing a discharge curve with voltages (V) of cell as ordinate against discharge times (h) as abscissa, and estimating the value from the discharge curve. Herein, the representation of “1 C” means the current value that brings the electrical discharge end for one hour when the above-mentioned three pole type coin cell undergoes the constant-current discharge (current value that reaches the electrical discharge end voltage). With respect to the three pole type coin cells of Examples 2 and 3, it was possible to perform charge and discharge up to the 20th cycle. On the other hand, with respect to the three pole type coin cells of Comparative Examples 2 and 3, it was impossible to perform charge and discharge in cycles after the second cycle.

In addition, with respect to the three pole type coin cell of Example 4, which used the negative plate in which the material for negative plate in which particulate magnesium metal and particulate allotrope of carbon were in contact with each other in part was provided on the copper foil as the supporting substrate, it was demonstrated that the cell was able to perform charge and discharge in cycles after the second cycle. Concretely, it was possible to perform charge and discharge up to the 20th cycle.

The electrical charge and discharge efficiency of the three pole type coin cell of Example 5 at the second cycle was about 80%, while the electrical charge and discharge efficiency of the three pole type coin cell of Comparative Example 5 at the second cycle was 27%. This demonstrated advantages of the material for negative plate, the negative plate using the material, and the magnesium ion rechargeable battery using the material according to the present invention. Herein, the electrical charge and discharge efficiency (%) at the second cycle was the value calculated from the formula:

[(charge capacity after the charge of the second cycle)/(discharge capacity after the discharge of the second cycle)]×100;

and the higher the value of this efficiency becomes, the more the battery characteristics are superior. In addition, with respect to the three pole type coin cell of Example 5, it was possible to perform charge and discharge up to the 20th cycle. On the other hand, with respect to the three pole type coin cell of Comparative Example 4, it was impossible to perform charge and discharge in cycles after the third cycle.

Examples 6 and 7 were the examples where the same allotrope of carbon with those used in Example 1-5 was used, and which differ from Example 1-5 in the electrolyte and magnesium metal used. Examples 8-14 were the examples which differ from Example 1-5 in the allotrope of carbon used. Further, among these Examples, differentiations were made appropriately with respect to the material of magnesium metal and electrolyte used. When the charge and discharge test at the above mentioned voltage range was performed, it was possible to perform charge and discharge at cycles after the second cycle with respect to ail of the three pole type coin cells of Examples 6-14.

As it was clear from the results of using the three pole type coin cells of Examples 6-14, excellent results were able to be obtained as is the case with Examples 1-5, even when using the allotropes of carbon other than the graphite used in Examples 1-5, and even when using the graphites which differed from the graphite used in Examples 1-5 in their crystallinity. Therefore, it became clear that the functions and effects of the present invention would be expected in each case of using a varying kind of allotrope of the carbon, as far as the allotrope of the carbon used is belong to allotropes of the carbon.

### EXPLANATION OF NUMERALS

10 Material for negative plate of magnesium ion rechargeable battery
1 Magnesium metal
2 Allotrope of carbon
20 Supporting substrate
30 Negative plate
32 Positive pole terminal
33 Negative pole terminal
34 Protection circuit board
35 Externally connecting connector
36a and 36b Resin container
37 Edge case
38a and 38b Externally connecting window
40 Positive plate
81 Exterior
100 Magnesium ion rechargeable battery
200 battery pack

1. A material for a negative plate of a magnesium ion rechargeable battery comprises magnesium metal and an allotrope of carbon, wherein the magnesium metal and the allotrope of carbon are in contact with each other at least in part.

2. A negative plate for a magnesium ion rechargeable battery comprising the material according to claim 1.

3. A magnesium ion rechargeable battery comprising a positive plate, a negative plate and an electrolyte, wherein the negative plate comprises the material according to claim 1.

4. A battery pack comprising a storage case, a magnesium ion rechargeable battery, and a protection circuit which possesses an over-charge protection function and an over-discharge function, wherein the magnesium ion rechargeable battery and the protection circuit are stored in the storage case, wherein the magnesium ion rechargeable battery comprises a positive plate, a negative plate and an electrolyte, and wherein the negative plate comprises the material according to claim 1.
